(19) United States
(12) Patent Application Publication
(10) Pub. No.: US 2026/0141797 A1
(43) Pub. Date: May 21, 2026

(54) WATER FILTRATION DEVICE PERFORMANCE MONITORING SYSTEM

(71) Applicant: Rorra Inc., Wilmington, DE (US)

(72) Inventors: Alex Fedorchenko, Astoria, NY (US); Joseph Guerra, New York, NY (US); Evan Dempsey, Brooklyn, NY (US); Garret McGregor, New York, NY (US); Brandon Lau, Queens, NY (US); Pierre Chan, Wilmington, DE (US); Andrew Lau, Wilmington, DE (US)

(21) Appl. No.: 19/392,832

(22) Filed: Nov. 18, 2025

Related U.S. Application Data
(60) Provisional application No. 63/723,514, filed on Nov. 21, 2024.

(51) Int. Cl. G08B 21/18; B01D 35/143; C02F 1/00; G08B 7/06

(52) U.S. Cl. CPC G08B 21/182; B01D 35/1435; C02F 1/003; C02F 1/008; G08B 7/06; C02F 2201/009; C02F 2209/445

(57) ABSTRACT

A water filtration device performance monitoring system includes a water container configured to hold a volume of water for distribution; one or more sensors disposed in association with the water container and configured to measure a weight corresponding to an amount of water contained within the water container; a processing unit operatively coupled to the one or more sensors and configured to determine a cumulative volume of water filtered through a filter based on sequential weight measurements of the water container, and determine a remaining filter life based on the cumulative volume of water filtered through the filter; and

an indicator system configured to communicate a status of the remaining filter life to a user.

### CROSS-REFERENCE TO RELATED APPLICATION

This application claims the benefit of and priority to U.S. Provisional Patent Application No. 63/723,514 filed on Nov. 21, 2024, the entire disclosure of which is hereby incorporated by reference in its entirety for all purposes.

### TECHNICAL FIELD

This disclosure relates generally to water filtration and distribution technologies, and more particularly to systems and methods for monitoring the performance and usage of water filtration devices using sensor-based measurements.

### BACKGROUND

Monitoring the usage and performance of water filters is essential to ensure consistent delivery of clean and safe water. Conventional water filtration systems typically rely on predetermined replacement intervals based on either elapsed time (e.g., every six months) or estimated water volume (e.g., 1,000 gallons). However, most systems lack a mechanism to directly measure the actual amount of water filtered through the water filtration device. As a result, users often depend solely on time-based replacement schedules, which can lead to premature or delayed filter replacement. For example, a household water distribution system serving a small family may experience significantly different water usage compared to an office or commercial system serving multiple users. Consequently, the same time-based replacement interval may not accurately reflect the true wear and capacity of the filter in different environments.

Existing approaches to estimating filter performance, such as monitoring water quality, physical wear, or flow rate, are often indirect and unreliable. Physical wear may vary for reasons unrelated to filter usage, and changes in flow rate can be influenced by mechanical issues rather than filter degradation. For instance, external vibrations from nearby equipment, rough handling during installation or cleaning, or exposure to temperature fluctuations can cause the filter casing or housing materials to degrade without any correlation to the actual amount of water processed. Similarly, water flow rate changes within a filtration system may result from mechanical issues rather than filter degradation. For example, a partially obstructed outlet valve, mineral buildup in connecting pipes, or pump pressure variations may alter the perceived flow rate, misleading the system or the user into believing that the filter is clogged or nearing the end of its life when it is not. These factors can result in inaccurate assessments of filter condition and inefficient maintenance practices.

Accordingly, there remains a need for an accurate, reliable, and user-friendly system capable of monitoring actual water usage in a water filtration device. Such a system should provide direct measurement of the water filtered through the system, enabling precise determination of filter life and timely replacement without requiring complex calibration or water quality testing.

### SUMMARY

The present disclosure addresses the above-mentioned problems and other problems in the existing water filtration and distribution devices by providing systems and methods for monitoring the performance and usage of water filtration devices using sensor-based measurements.

In one aspect, the disclosure provides a water filtration device performance monitoring system, and the system includes a water container configured to hold a volume of water for distribution; one or more sensors disposed in association with the water container and configured to measure a weight corresponding to an amount of water contained within the water container; a processing unit operatively coupled to the one or more sensors and configured to determine a cumulative volume of water filtered through a filter based on sequential weight measurements of the water container, and determine a remaining filter life based on the cumulative volume of water filtered through the filter; and an indicator system configured to communicate a status of the remaining filter life to a user.

In another aspect, the disclosure provides a method for determining filter life of a water filtration device, and the method includes measuring, by one or more sensors, an initial weight of a water container associated with the water filtration device; measuring, by the one or more sensors, a subsequent weight of the water container after dispensing water; calculating, by a processing unit, a difference between the initial weight and the subsequent weight; determining a cumulative volume of water filtered through the water filtration device based on sequential weight differences; comparing the cumulative volume to a predefined filter capacity; and indicating, through an indicator system, a remaining filter life or a need for filter replacement based on the comparison.

In another aspect, the disclosure provides a method for determining a water level in a water filtration device, and the method includes detecting, by one or more sensors, a current weight of a water container; converting the detected weight into a corresponding water volume by a processing unit; comparing the converted water volume with a maximum storage capacity; and displaying, through an indicator system, a water level status corresponding to the converted volume, where the indicator system provides a first output when the water level exceeds a threshold and a second output when the water level falls below the threshold.

The foregoing is a summary and thus contains, by necessity, simplifications, generalizations, and omissions of detail; consequently, the summary is illustrative only and is not limiting in any way. Other aspects, inventive features, and advantages of the systems and/or processes described herein may become apparent in the non-limiting detailed description set forth herein.

### DETAILED DESCRIPTION

The disclosed embodiments have advantages and features that will be more readily apparent from the detailed description, the appended claims, and the accompanying figures (or drawings). A brief introduction of the figures is below.

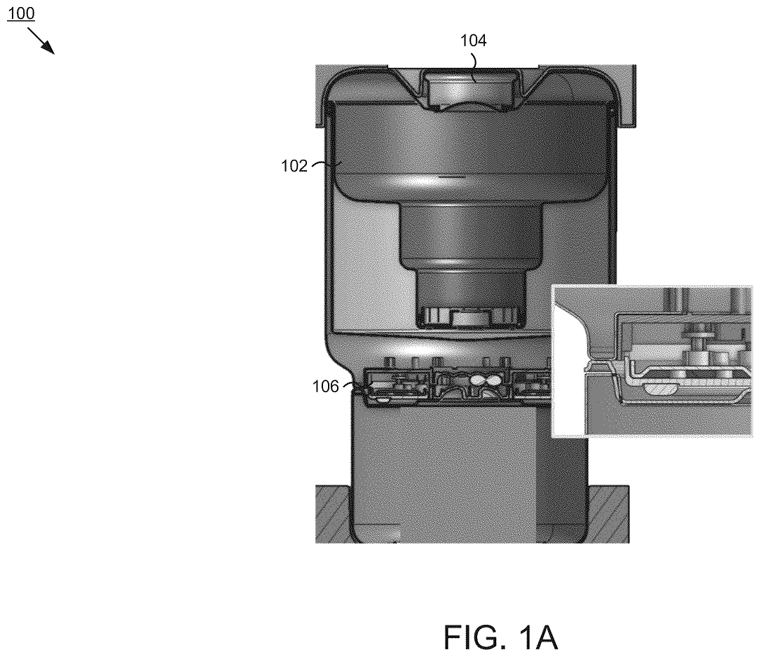

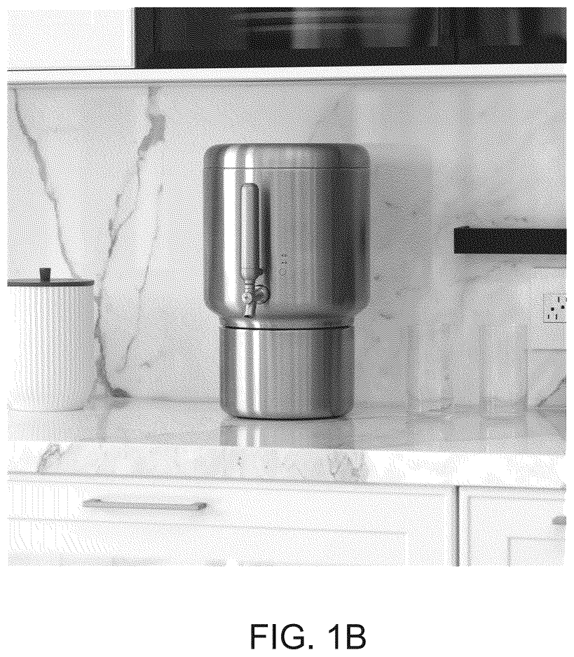

FIG. 1A illustrates an example water filtration device performance monitoring system, according to some embodiments of the disclosure.

FIG. 1B illustrates an example water filtering device including a water container mode of metal, according to some embodiments of the disclosure.

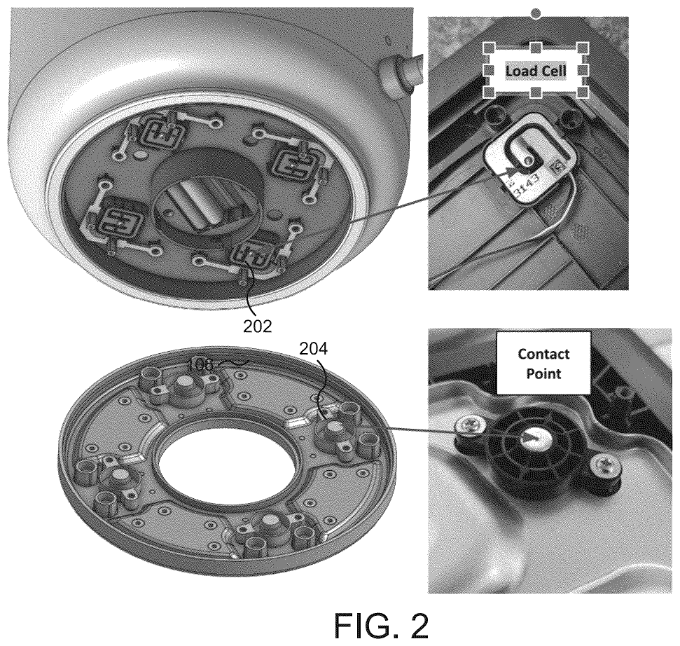

FIG. 2 illustrates an example architecture of a sensor-based weighting system, according to some embodiments of the disclosure.

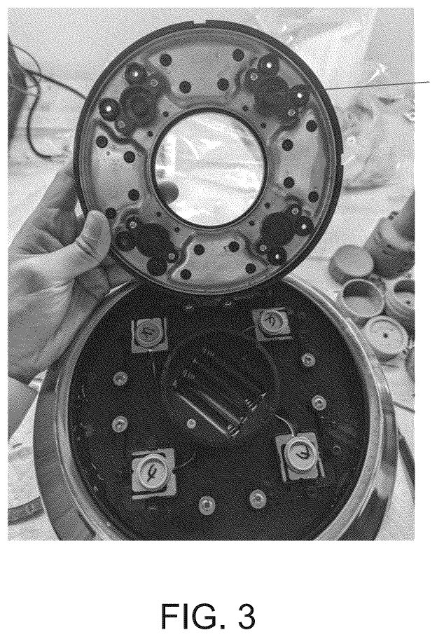

FIG. 3 illustrates example images of a prototype of a sensor-based weighting system, according to some embodiments of the disclosure.

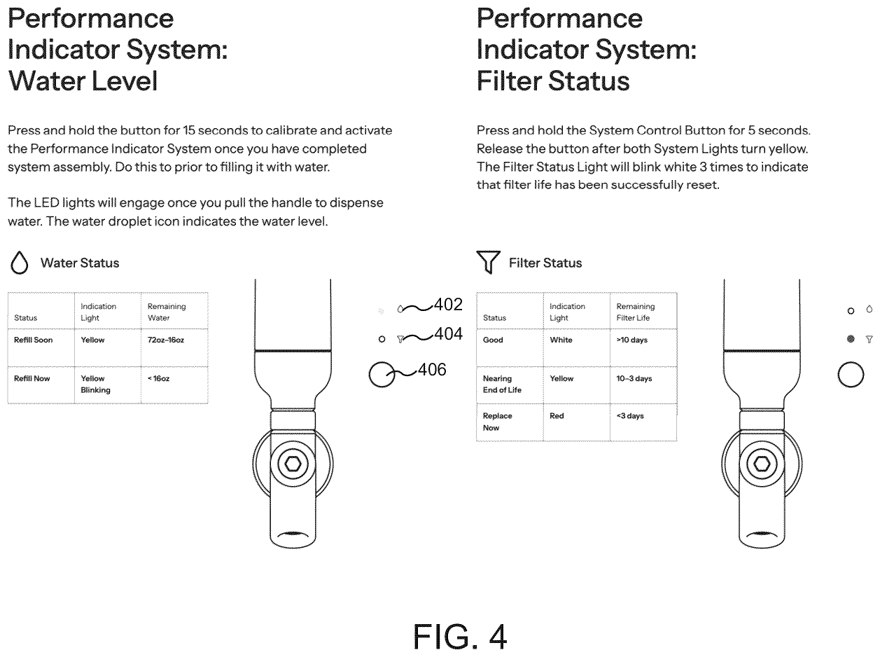

FIG. 4 illustrates some example water level and filter status indicators and control for a water filtration device performance monitoring system, according to some embodiments of the disclosure.

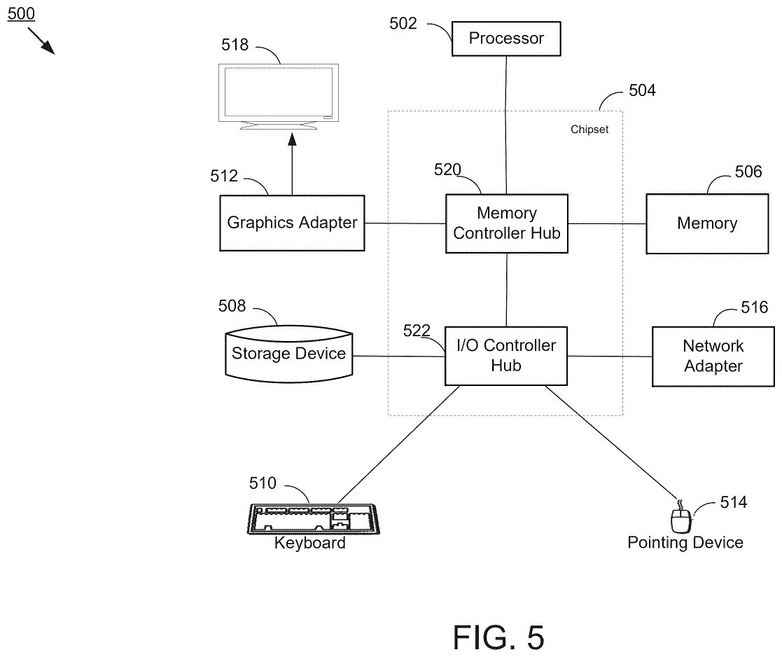

FIG. 5 illustrates an example computing unit or microcontroller for implementing the disclosed technology, according to some embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of the present disclosure.

Reference will now be made in detail to several embodiments, examples of which are illustrated in the accompanying figures. It is noted that wherever practicable, similar or like reference numbers may be used in the figures and may indicate similar or like functionality. The figures depict embodiments of the disclosed system (or method) for illustration purposes only. One skilled in the art will readily recognize from the following description that alternative embodiments of the structures and methods illustrated herein may be employed without departing from the principles described herein.

To address the foregoing and other challenges associated with existing filter-based water distribution systems, the present disclosure provides a water filtration device performance monitoring system configured to accurately track water usage and determine filter life based on actual water flow through the system. The disclosed system employs one or more sensors to dynamically monitor the total amount of water contained within a filtration device, thereby enabling continuous measurement of water levels over time. By consistently recording these measurements, the system may determine the volume of water that has passed through the filter and, in turn, estimates the remaining filter life. This approach allows users to identify the appropriate time for filter replacement based on real usage data rather than preset time intervals, thereby ensuring more efficient filter utilization. For instance, the system may accurately monitor the performance of a filter rated for a 200-gallon lifespan by correlating cumulative water weight or volume data with the filter's predefined capacity threshold.

Compared to conventional filter monitoring approaches, the disclosed system offers several advantages. Unlike methods that rely on direct contact with the filter, such as those using chemical indicators, the present system is non-invasive, thereby avoiding potential contamination or premature filter degradation. Furthermore, by basing its analysis on actual water usage data rather than time intervals, flow rate fluctuations, or subjective wear indicators, the disclosed system provides greater accuracy and reliability in estimating filter performance. Traditional techniques that depend on physical wear inspection or flow rate monitoring may produce inconsistent results. Physical deterioration may occur due to environmental factors such as vibration, temperature variation, or handling stress, while flow rate changes may stem from unrelated mechanical issues such as clogged valves, mineral deposits in pipes, or pump pressure irregularities. In contrast, the disclosed system directly correlates measurable water volume or weight with filter usage, thereby enabling precise, user-friendly, and maintenance-efficient monitoring of filter life.

In addition to its accuracy and reliability, the disclosed water filtration device performance monitoring system provides enhanced user convenience and integration flexibility. For example, a user may easily determine the remaining filter life or current water level at any time with minimal interaction, such as pressing a button or actuating a handle, to trigger an LED indicator or display. Unlike systems that require periodic water quality testing or complex sensor calibration, the disclosed system delivers immediate and intuitive feedback regarding water level and/or filter status. Moreover, the system is designed for seamless incorporation into existing filter-based water distribution systems without the need for complicated structural modifications or specialized installation. The modular and sensor-based architecture may also be adapted for use in other liquid filtration or monitoring applications, such as fuel or lubricant filters in automotive or industrial systems.

It should be understood that the benefits and advantages described herein are not intended to be exhaustive and that additional features will become apparent through the following detailed description and accompanying drawings. Certain advantages may be emphasized in specific embodiments; however, these examples are provided for illustration and not limitation. Moreover, one of ordinary skill in the art will recognize that various modifications, equivalents, and alternative configurations may be employed without departing from the scope or spirit of the present disclosure.

FIG. 1A illustrates an example embodiment of a water filtration device performance monitoring system 100, configured to determine the amount of water that has passed through a filtration device and to estimate corresponding filter performance. As illustrated in the figure, the system 100 may include a filter-based water distribution system having a water container 102 configured to hold a volume of water for distribution to one or more users. The water container may take various forms, such as a tank, bottle, or reservoir, and may be fabricated from plastic, metal, glass, or composite materials suitable for potable water applications. The shape of the container may be cylindrical, rectangular, or any ergonomic geometry conducive to installation or portability. In some embodiments, the container includes a fill port (or refill port) 104 for introducing water and a distribution port (or outlet port) through which filtered water is dispensed.

In some embodiments, the water container is not transparent, and thus it may be difficult to tell the water level in the container. FIG. 1B illustrates an example water container that is fabricated from metal, and thus it is difficult to tell the water level in the container. Accordingly, a proper way to determine the water level in the container may be necessary.

In some embodiments, the water container 102 may be coupled to a filter element positioned along the water flow path to remove contaminants or particulates from the water. The filter may be of a conventional or advanced type, such as activated carbon, reverse osmosis, ceramic, or ion exchange, and may have a rated filtration capacity defined by volume (e.g., 200 gallons). The system may be designed to accommodate replaceable filter cartridges or integrated filter modules, depending on the intended use case.

In some embodiments, the system 100 further includes a sensor-based monitoring system 106 configured to detect and record weight, volume, or other water-level data associated with the water container 102. The monitoring system 106 may include a plurality of sensors, such as load cells, strain gauges, or piezoelectric sensors, arranged at or beneath the base of the container to continuously or intermittently measure the total weight of the container and its contents. In some implementations, capacitive, optical, or ultrasonic sensors may also be used either alone or in combination with weight sensors to improve accuracy or redundancy. In some embodiments, the monitoring system may be calibrated such that the empty container weight is zeroed, thereby enabling direct correlation between measured weight and the volume of water present at any given time.

In some embodiments, the system may store sequential weight data to calculate water consumption over time, thereby allowing the processor to compute both the instantaneous water level and cumulative water usage. This configuration enables the system to determine real-time filter life consumption and predict replacement intervals with higher precision than conventional time-based systems.

In one representative embodiment, the monitoring system 106 includes four weight sensors distributed near the corners of a rectangular or square base plate. In other embodiments, the number and placement of sensors may vary according to the size, shape, and weight distribution of the container. For instance, circular or compact containers may employ three equidistant sensors, while larger industrial containers may use six or more sensors for load balancing and redundancy. Each weight sensor may be mounted on a support platform designed to ensure accurate force transmission and minimize measurement noise caused by vibration or uneven surfaces.

In some embodiments, the system may also include a protective enclosure or housing containing the sensors, electronics, and power components. The enclosure may incorporate shock-absorbing pads or adjustable feet to maintain stable positioning on uneven surfaces. Additionally, the monitoring system may be integrated into a detachable base unit, allowing users to retrofit existing water dispensers or filters without complicated structural modification.

The system 100 may further include a processing unit or microcontroller operatively connected to the sensors. The processing unit may receive analog or digital signals representing the weight measurements, convert them into corresponding water volumes, and store or transmit the processed data. In some embodiments, the processing unit may employ an analog-to-digital converter (ADC) and a signal conditioning circuit comprising amplifiers, filters, and calibration software to improve data accuracy.

In some embodiments, the processing unit may also execute algorithms to determine filter life based on cumulative water usage, perform predictive analytics to forecast replacement timing, and manage user notifications. In some embodiments, the processing unit may include a wireless communication interface (e.g., Bluetooth®, Wi-Fi®, Zigbee®, or LoRa®) that allows data to be transmitted to a companion mobile application, cloud service, or remote monitoring platform. This enables users to review historical water usage, receive maintenance alerts, or integrate the system into broader smart-home or industrial monitoring frameworks.

In some embodiments, the system may further include one or more indicators or user interfaces for presenting information about water level and filter status, as further described in detail in FIG. 4. In some embodiments, the system may optionally include a control button or calibration switch that enables a user to reset the filter life counter, recalibrate the sensors, or manually activate display indicators, as also described in detail in FIG. 4

In some embodiments, the system 100 is self-contained and battery-powered, enhancing portability and versatility. The power supply may consist of disposable or rechargeable batteries, such as AAA, lithium-ion, or nickel-metal hydride cells. To conserve energy, the processing unit may operate in a low-power standby mode, activating the sensors and indicators only during specific events, such as when water is added, dispensed, or the user interacts with the interface. Optionally, a solar or kinetic charging module may be integrated to extend operational life in off-grid environments.

The disclosed system can be configured for a range of applications, including household water dispensers, filtered showerheads, office filtration units, automotive fluid filters, industrial process filters, and other liquid-handling systems requiring usage-based performance monitoring.

FIG. 2 illustrates an example architecture of a sensor-based weighing system 200, which may be employed in the water filtration device performance monitoring system 100 of FIG. 1A. As shown, the weighing system 200 includes one or more load cells 202 that convert mechanical force (i.e., the weight of the water container and its contents) into corresponding electrical signals. Each load cell 202 may be formed from aluminum, stainless steel, or another structurally rigid material capable of slight elastic deformation under applied load. The load cell may incorporate one or more strain gauges bonded to its surface that detect micro-deformations caused by changes in weight. The strain gauges may be arranged in a Wheatstone bridge configuration (or in other electrical configurations), producing a differential voltage signal proportional to the applied force.

In some embodiments, the system may include multiple load cells arranged at different positions, such as the four corners of a rectangular support base, to measure distributed weight. The system may then calculate an average or weighted reading from all sensors to enhance accuracy and mitigate localized anomalies caused by uneven loading, surface irregularities, or user interaction. The architecture may further include contact points 204 (aligned with the load cells, which provide stable, static interfaces between the water container and each load cell), thereby ensuring consistent measurement alignment and reducing frictional error.

The weighing system 200 may further include a signal conditioning circuit configured to amplify, filter, and digitize the raw analog signals from the load cells 202. The circuit may include a precision instrumentation amplifier, an ADC, and a noise suppression filter, such as a low-pass or notch filter. In some embodiments, the signal conditioning circuit may be implemented on a printed circuit board (PCB) mounted beneath the load cell assembly. The conditioned signals may then be transmitted to the system's processing unit, which interprets the voltage changes and converts them into corresponding weight or volume readings.

Alternative embodiments may use other types of sensors in addition to or in place of load cells. Examples include piezoelectric sensors (for detecting force or pressure variations), capacitive sensors (for measuring displacement), optical displacement sensors, or microelectromechanical system (MEMS)-based sensors for compact and high-precision designs. The system may further include a temperature compensation circuit to correct for environmental effects on strain gauge resistance or material expansion.

To maintain measurement stability, the weighing system 200 may be positioned on a flat support surface and isolated from vibration sources. A gap or clearance may be provided between the weighing system and adjacent housing components, allowing free sensor movement as weight changes occur during filling or dispensing operations. The mechanical design may also incorporate elastomeric isolators, springs, or damping pads to minimize transient oscillations and protect sensitive components.

In some embodiments, the number, placement, and configuration of sensors may be adapted to suit different use cases. For instance, portable tabletop dispensers may utilize a four-sensor layout, while large-scale industrial tanks may employ multi-sensor grids or ring-shaped sensor arrays for uniform load distribution. The system architecture is therefore scalable and modular, enabling application in diverse fluid monitoring environments beyond water filtration.

The processing unit, as illustrated in FIG. 2, may further include integrated logic for sensor calibration, drift compensation, and event detection. Upon installation or replacement of a filter, the system may initiate a calibration routine to establish a baseline (zero-load) weight reference. Thereafter, incremental changes in weight are continuously or intermittently recorded and analyzed. The system may use differential data sampling to calculate the net water dispensed or refilled, providing a dynamic profile of user consumption patterns.

In some embodiments, the processing unit may also employ machine-learning or rule-based algorithms to identify abnormal usage patterns, detect leaks, or predict filter clogging based on deviations in expected weight change behavior. For example, if the system detects persistent micro-variations in weight without corresponding water output, it may infer slow leakage or evaporation and notify the user accordingly.

In some embodiments, the processed data may be stored locally in non-volatile memory, such as flash or electrically erasable programmable read-only memory (EEPROM), to maintain historical usage logs even when power is removed. The processing unit may also communicate with external systems via wired or wireless connections. For instance, data can be transmitted to a mobile application, cloud storage service, or local gateway using communication protocols such as Bluetooth low energy (BLE), Wi-Fi®, Zigbee®, or near-field communication (NFC). Remote access allows users to view filter life, consumption trends, and refill reminders through graphical dashboards or notifications.

In some embodiments, the communication interface may further support firmware updates or parameter adjustments (e.g., threshold calibration, LED indicator settings) over-the-air. This enhances device longevity and compatibility with future system updates.

It should be noted that, while FIG. 2 primarily illustrates an embodiment utilizing weight-based sensing, other embodiments may combine or substitute alternative sensing principles. For example, the system may employ flow sensors, pressure transducers, or ultrasonic liquid level sensors that measure water displacement directly within the container or conduit. These sensors may operate independently or in parallel with the load-cell-based system to create a redundant hybrid configuration, improving robustness and data accuracy. Additionally, the system may be adapted to monitor liquid properties such as temperature, turbidity, or conductivity to provide broader performance diagnostics for both the filter and the overall water quality.

FIG. 3 illustrates example images of a prototype implementation of the sensor-based weighing system described herein. The prototype demonstrates the structural and functional integration of the weighing platform, sensor arrangement, and processing circuitry within a compact enclosure. The illustrated embodiment includes a base plate supporting four load cells located at approximate corner positions to ensure stable measurement under various load distributions. Each load cell is mounted on a rigid support frame to provide direct load transfer from the water container to the sensing elements, minimizing frictional or lateral force interference. The central region of the prototype houses an electronics compartment containing a PCB with the signal conditioning circuits, microcontroller, power management components, and battery interface.

It should be noted that the mechanical layout may be adapted to suit different container geometries or installation environments. For instance, a circular housing may employ a ring-shaped sensor array, while larger systems may utilize a modular base comprising multiple sensor tiles connected via a communication bus. The use of interchangeable modules allows scalability across a range of filter systems, from small countertop water dispensers to large-capacity commercial filtration units. Each module may be individually calibrated and automatically synchronized with the main control unit, enabling quick maintenance and component replacement.

The prototype shown in FIG. 3 further illustrates optional design features that enhance usability and system durability. The housing may be formed from injection-molded plastic or die-cast metal with moisture sealing elements to protect internal electronics from splashing or condensation. The system may include vibration isolation pads positioned between the load cells and the supporting surface to prevent measurement drift caused by external motion. The weight sensors may be equipped with temperature compensation resistors or software-based correction factors to maintain accuracy over a wide range of operating conditions.

In some configurations, the prototype may include integrated ports for wired communication (for example, USB or serial connectors) to allow data export, firmware update, or factory-level calibration. The system may further provide a modular battery compartment with a slide-out tray for easy replacement. In portable implementations, rechargeable batteries may be used in conjunction with a charging port or wireless charging coil embedded in the device housing.

In some embodiments, the weighing system may be designed as an independent accessory attachable to a variety of water containers or filter housings. For instance, a universal base may be provided that can mechanically couple to multiple container types via clips, threaded connections, or magnetic mounts. This approach enables existing water dispensers to be retrofitted with minimal modification. In alternative embodiments, the weighing system may be integrated into the structure of a smart water dispenser or purification unit at the point of manufacture. Integration at the design level allows more efficient cable routing, enhanced waterproofing, and direct connection to existing display or wireless modules within the appliance.

The weighing system may also be combined with additional environmental or operational sensors. For example, a humidity or temperature sensor may be included to monitor ambient conditions that may affect filter performance or water quality. A pressure or flow sensor may be integrated along the water outlet line to provide a secondary data source for verifying filter flow rate and detecting anomalies. These additional inputs can be used by the processing unit to perform cross-verification of measured water usage or to trigger diagnostic routines when inconsistencies occur between weight-based and flow-based data.

In some embodiments, the processing unit may employ an adaptive data fusion algorithm that dynamically adjusts calibration factors based on multi-sensor input. This hybrid configuration may provide enhanced reliability and long-term stability in demanding environments, such as industrial facilities, laboratories, or field-deployed water purification systems.

The design flexibility of the disclosed system also allows it to be applied to fluid monitoring systems beyond water filtration. For example, the same core technology may be adapted for monitoring fuel filters in automotive applications, oil filters in machinery, or coolant filtration systems in industrial or marine environments. The fundamental principle, tracking usage by measuring dynamic changes in contained fluid mass, remains applicable across a variety of liquids and operational conditions. Modifications may include selecting appropriate sensor materials resistant to the target fluid, adjusting the calibration parameters for density differences, or integrating protective coatings to prevent corrosion or chemical degradation.

Such versatility ensures that the disclosed system can be implemented across multiple industries while maintaining the same basic sensing, computation, and indicator functions to track filter life and fluid usage accurately.

FIG. 4 illustrates example indicator and control elements that can be incorporated into the water filtration device performance monitoring system 100. In one embodiment, the system includes a water level indicator 402 configured to visually display the current water level or volume remaining within the container. The indicator may use one or more LEDs, an LCD screen, or an electronic ink display to convey water level information in a simple and intuitive manner. For instance, the water level indicator may present a color-coded scheme in which green signifies sufficient water volume, yellow indicates a medium level suggesting that refilling will soon be required, and red signals that the water level is critically low.

In some embodiments, the indicator may be responsive to user interaction, such as the actuation of a handle or a button press, to conserve power. For example, the indicator may illuminate only when the system detects that water is being dispensed or when a user input is received. In other embodiments, the system may employ motion detection or capacitive touch sensing to activate the display automatically when the user approaches or touches the device. These approaches improve user convenience while maintaining battery efficiency.

The system may further include a filter status indicator 404 configured to communicate the current condition or remaining life of the installed filter. The filter status indicator may employ multiple visual or audible modes, such as steady and flashing color changes, to indicate different stages of filter wear. For instance, a white light may indicate that the filter is operating within its normal service range, a yellow light may indicate that the filter is approaching the end of its useful life, and a red light may indicate that replacement is required. In addition to visual cues, the system may generate audible tones, haptic vibration feedback, or wireless notifications (e.g., through a mobile application or smart-home interface) to alert users when maintenance is due.

In alternative embodiments, the filter status indicator may display numerical information, such as the remaining percentage of filter life, or a bar graph representing the cumulative filtered volume compared to the rated capacity. Such variations allow users to choose between minimalist visual feedback and more detailed digital readouts depending on application requirements.

In some embodiments, a system control button 406 may also be provided to facilitate manual interaction with the system. The button may serve multiple purposes, such as system calibration, filter reset, power control, or activation of maintenance modes. For example, pressing and holding the button for a predetermined duration, such as five seconds, may initiate a filter reset routine following filter replacement. Pressing and holding for a longer period, such as fifteen seconds, may activate a full calibration sequence that reestablishes the zero-load baseline for the weight sensors. The system may confirm these actions through visual or auditory feedback, such as LED blinking sequences or short beeps.

In some embodiments, the system control button 406 may be replaced or supplemented by a capacitive touch sensor, a rotary dial, or a touch-screen control interface. These alternatives may be preferable for compact or sealed devices where minimizing physical openings enhances waterproofing. Additionally, the system may support remote control via wireless commands transmitted from a paired smartphone or computing device.

To further enhance usability, the indicator and control system may integrate intelligent feedback features that adapt to user behavior. For instance, the system may automatically dim or deactivate indicator lights after a defined period of inactivity to preserve battery power. Conversely, the indicators may brighten or flash temporarily when a refill or filter replacement is imminent. In some embodiments, the processing unit may log user interactions with the control button or display to assess usage frequency and adjust future reminder intervals accordingly.

In another embodiment, the system may provide real-time status updates through a connected mobile application. The application may display current water level, estimated filter life, historical usage graphs, as well as notifications prompting the user to refill the container or replace the filter. Integration with virtual assistants or smart-home ecosystems (for example, Amazon Alexa®, Google Assistant®, or Apple HomeKit®) may further allow the system to issue voice-based alerts or respond to spoken queries about system status.

In still other embodiments, the system may incorporate advanced interface technologies to improve accessibility and customization. The indicators may include programmable lighting patterns that allow users to select preferred colors or brightness levels. The control interface may support multi-function gestures or sequential button presses to navigate through operational modes. For industrial or laboratory environments, the system may include an external data port or digital output that transmits indicator signals to centralized monitoring systems or supervisory control panels.

Additionally, the indicator subsystem may include environmental sensors for ambient light detection, allowing automatic adjustment of display brightness to maintain visibility in various lighting conditions. The combination of adaptive display control, wireless communication, and programmable user feedback provides a highly flexible interface architecture suitable for both consumer and professional applications.

### Operational Examples and System Use Cases

In operation, the water filtration device performance monitoring system 100 determines water usage and filter life through a sequence of weight-based measurements. The system is initially calibrated with an empty water container to establish a baseline reference value representing zero water content. When the container is filled, the sensors measure the total weight of the container and its contents. This initial reading provides a reference value for the full water level. Each time water is dispensed, the system measures the updated weight, and the difference between consecutive readings corresponds to the amount of water removed from the container. By continuously recording these weight differentials over time, the system calculates the cumulative volume of water that has passed through the filter.

In one illustrative example, the container has a capacity of 2.5 gallons (approximately 20.8 pounds of water), and the installed filter is rated for 200 gallons of use (approximately 1,665.8 pounds of water). When a user adds 2 gallons (16.7 pounds) of water to the container, the sensors register the change in weight, and the processing unit logs the refill event. If the user dispenses 0.5 gallons of water, the sensors detect a weight reduction of approximately 4.2 pounds. The processing unit updates the cumulative usage total accordingly and deducts the corresponding volume from the remaining filter life.

To accommodate various operating environments, the system may employ different algorithms for data sampling and processing. In some embodiments, the processing unit records data at fixed intervals, such as every few seconds during active dispensing or refilling, and less frequently when the system is idle. In other embodiments, the system may operate in an event-driven mode, capturing measurements only when a significant weight change exceeds a defined threshold. This event-based approach minimizes data redundancy and conserves processing power and memory.

The filter life may be expressed in multiple formats, including total gallons or liters processed, remaining percentage of life, or estimated days of service remaining. The system may dynamically update these values based on actual usage patterns, ambient temperature, or historical consumption data. For example, in environments with high water consumption, the system may adjust the estimated replacement interval to better match real-world conditions.

The system may also include automatic calibration and error detection routines. For example, when a new filter is installed, the user may trigger a filter reset function using the control button or a connected application. The processing unit then initializes a new filter life cycle and resets the cumulative usage counter. The system may also periodically perform self-calibration by verifying that weight readings return to baseline when the container is empty. If significant deviations are detected, the system may prompt the user to perform a manual calibration sequence.

In some embodiments, the system may detect anomalies such as partial blockages, leaks, or sensor drift. For instance, if a persistent weight decrease is recorded without corresponding user activity, the system may interpret this as leakage or evaporation and generate an alert. Similarly, if weight readings fluctuate excessively due to vibration or environmental interference, the system may automatically average multiple readings or apply digital filtering to maintain stable performance.

To enhance functionality and predictive maintenance capability, the system may employ data analytics or machine-learning models to forecast filter replacement timing. Historical usage data may be analyzed to identify consumption trends and estimate the remaining effective lifespan of the filter under current operating conditions. The system may also integrate with external data sources, such as water quality information or ambient temperature readings, to refine its predictive accuracy. For instance, if the system detects increased turbidity or particulate matter in the water supply, it may shorten the predicted filter life to account for faster clogging or degradation.

In some embodiments, the processing unit may generate maintenance reports accessible through a companion application or cloud-based dashboard. These reports may include daily and cumulative water consumption, filter health summaries, and estimated replacement schedules. The predictive algorithms may thereby help users plan filter replacement proactively, ensuring consistent water quality and minimizing downtime.

In some embodiments, the disclosed system may also include multiple operational modes to suit different user preferences and environments. A basic mode may provide essential features such as water level indication and filter status display, while an advanced mode may include wireless connectivity, detailed analytics, and integration with external devices. Industrial or laboratory versions of the system may further include data export capabilities for compliance logging or quality control documentation.

In some embodiments, the system may interface with remote maintenance services. For example, when a filter is nearing the end of its lifespan, the system may automatically transmit a replacement request or notify a service provider through an online platform. Integration with supply chain systems allows automated inventory management and streamlined delivery of replacement filters to end users.

The system's flexibility and modular design enable its use across a wide range of liquid filtration applications beyond potable water systems. For example, the same weight-based sensing principles may be applied to oil, coolant, or fuel filters used in automotive, marine, or industrial settings. The system may also be employed in laboratory filtration systems, beverage dispensers, or agricultural irrigation systems, where monitoring of filter status and liquid consumption is critical. Adjustments such as material selection, corrosion resistance, and calibration scaling may be made to accommodate different fluids and environmental conditions.

Additionally, the disclosed monitoring approach may be adapted for non-filtration applications where precise measurement of liquid usage or container fill level is desired, such as in chemical dispensing systems or environmental monitoring stations. By decoupling the sensing mechanism from the liquid path, the system remains non-invasive and easily adaptable to diverse applications.

It should be understood that the described embodiments are intended for illustration rather than limitation. Various modifications and equivalents will be apparent to those skilled in the art. The number and arrangement of sensors, the selection of materials, the configuration of indicators, and the algorithms used for data processing may all be modified without departing from the scope of the present disclosure. Moreover, individual features described in connection with one embodiment may be combined with or substituted for features of another embodiment as appropriate for a given implementation.

The described system and methods thus provide an adaptable and accurate framework for determining the performance and remaining life of a filter in any liquid distribution system through non-invasive, sensor-based monitoring of liquid usage.

### System and/or Computer Embodiment

FIG. 5 depicts an example computing unit or microcontroller 500 for implementing functions described in reference to FIGS. 1A-4. Examples of a computing unit or microcontroller may include a computing node within a cluster, message processors, microprocessor-based or programmable consumer electronics, edge devices, IoT devices, and the like. In some embodiments, the computing unit or microcontroller 500 may operate as an AI-powered unit. Thus, the computing unit or microcontroller 500 may train and/or deploy machine learning models for monitoring filter life or water level. It should be noted that the computing unit or microcontroller 500 may not be necessary to include all elements illustrated in FIG. 5 and described below.

In some embodiments, the computing unit or microcontroller 500 includes at least one processor 502 coupled to a chipset 504. The chipset 504 includes a memory controller hub 520 and an input/output (I/O) controller hub 522. A memory 506 and a graphics adapter 512 are coupled to the memory controller hub 520, and a display 518 is coupled to the graphics adapter 512. A storage device 508, an input interface 514, and a network adapter 516 are coupled to the I/O controller hub 522. Other embodiments of the computing unit or microcontroller 500 have different architectures.

The storage device 508 is a non-transitory computer-readable storage medium such as a hard drive, compact disk read-only memory (CD-ROM), DVD, or a solid-state memory device. The Memory 506 holds instructions and data used by the processor 502. The input interface 514 is a touch-screen interface, a mouse, a trackball, or other types of input interface, a keyboard, or some combination thereof, and is used to input data into the computing unit or microcontroller 500. In some embodiments, the computing unit or microcontroller 500 may be configured to receive input (e.g., commands) from the input interface 514 via gestures from the user. The graphics adapter 512 displays images and other information on the display 518. The network adapter 516 couples the computing unit or microcontroller 500 to one or more computer networks.

The computing unit or microcontroller 500 is adapted to execute computer program modules for providing the functionality described herein. As used herein, the term “module” refers to computer program logic used to provide the specified functionality. Thus, a module may be implemented in hardware, firmware, and/or software. In one embodiment, program modules are stored on the storage device 508, loaded into the memory 506, and executed by the processor 502.

The types of computing unit or microcontrollers 500 may vary from the embodiments described herein. For example, the computing unit or microcontroller 500 may lack some of the components described above, such as graphics adapters 512, input interface 514, and/or displays 518. In some embodiments, a computing unit or microcontroller 500 may include a processor 502 for executing instructions stored in a memory 506.

The methods disclosed herein may be implemented in hardware or software, or a combination of both. In one embodiment, a non-transitory machine-readable storage medium, such as the one described above, is provided, the medium comprising a data storage material encoded with machine-readable data which, when using a machine programmed with instructions for using said data, is capable of displaying any of the datasets and execution and results of this disclosure. Such data may be used for a variety of purposes, such as patient monitoring, treatment considerations, and the like. Embodiments of the methods described above may be implemented in computer programs executing on programmable computers, comprising a processor, a data storage system (including volatile and non-volatile memory and/or storage elements), a graphics adapter, an input interface, a network adapter, at least one input device, and at least one output device. A display is coupled to the graphics adapter. Program code is applied to input data to perform the functions described above and generate output information. The output information is applied to one or more output devices in a known fashion. The computer may be, for example, a personal computer, microcomputer, or workstation of conventional design.

Each program may be implemented in a high-level procedural or object-oriented programming language to communicate with a computer system. However, the programs may be implemented in assembly or machine language, if desired. In any case, the language may be a compiled or interpreted language. Each such computer program is preferably stored on a storage medium or device (e.g., ROM or magnetic diskette) readable by a general or special-purpose programmable computer, for configuring and operating the computer when the storage medium or device is read by the computer to perform the procedures described herein. The system may also be considered to be implemented as a computer-readable storage medium, configured with a computer program, where the storage medium so configured causes a computer to operate in a specific and predefined manner to perform the functions described herein.

The signature patterns and databases thereof may be provided in a variety of media to facilitate their use. “Media” refers to a medium that contains the signature pattern information of the present disclosure. The databases of the present disclosure may be recorded on computer-readable media, e.g., any medium that may be read and accessed directly by a computer. Such media include, but are not limited to: magnetic storage media, such as floppy discs, hard disc storage media, and magnetic tape; optical storage media such as CD-ROM; electrical storage media such as RAM and ROM; and hybrids of these categories, such as magnetic/optical storage media. One skilled in the art may readily appreciate how any of the presently known computer-readable mediums may be used to create a manufacture comprising a recording of the present database information. “Recorded” refers to a process for storing information on a computer-readable medium, using any such methods as known in the art. Any convenient data storage structure may be chosen, based on the means used to access the stored information. A variety of data processor programs and formats may be used for storage, e.g., word processing text files, database format, etc.

What is claimed is:

1. A water filtration device performance monitoring system, comprising:
a water container configured to hold a volume of water for distribution;
one or more sensors disposed in association with the water container and configured to measure a weight corresponding to an amount of water contained within the water container;
a processing unit operatively coupled to the one or more sensors and configured to:
determine a cumulative volume of water filtered through a filter based on sequential weight measurements of the water container, and
determine a remaining filter life based on the cumulative volume of water filtered through the filter; and
an indicator system configured to communicate a status of the remaining filter life to a user.

2. The system of claim 1, wherein the one or more sensors includes load cells arranged at spaced positions beneath the water container to provide distributed load measurement.

3. The system of claim 1, wherein each of the one or more sensors include a strain gauge arranged in a Wheatstone bridge configuration.

4. The system of claim 1, further comprising a signal conditioning circuit configured to amplify, filter, and digitize electrical signals from the one or more sensors.

5. The system of claim 1, wherein the processing unit includes a microcontroller programmed to calculate the cumulative volume of water filtered through the filter and to compare the calculated cumulative volume with a predefined filter capacity threshold.

6. The system of claim 5, wherein the microcontroller is further configured to activate a visual or auditory alert when the remaining filter life is below a predetermined threshold.

7. The system of claim 1, wherein the indicator system includes at least one light-emitting diode configured to emit different colors corresponding to distinct filter life stages.

8. The system of claim 1, wherein the indicator system includes a display configured to present numerical or graphical representations of a water level and a filter status.

9. The system of claim 1, further comprising a control interface configured to initiate calibration or filter life reset functions.

10. The system of claim 1, wherein the processing unit is configured to store sensor data in non-volatile memory and to transmit usage information to an external device via a wireless communication module.

11. The system of claim 1, wherein the one or more sensors are configured to provide redundant readings and the processing unit calculates an averaged result to improve accuracy.

12. The system of claim 1, wherein the system is battery-powered and includes a power management circuit configured to activate the one or more sensors only during water refill or dispensing events.

13. The system of claim 1, wherein the processing unit is configured to detect abnormal variations in measured weight indicative of leakage, evaporation, or mechanical interference.

14. The system of claim 1, wherein the processing unit is further configured to transmit a maintenance reminder or filter replacement notification to a mobile application or cloud platform.

15. The system of claim 1, wherein the system further includes one or more environmental sensors configured to measure temperature, humidity, or pressure and to compensate weight readings accordingly.

16. The system of claim 1, wherein the water container includes a refill port and an outlet port for dispensing filtered water, and the processing unit determines water usage based on measured weight differentials between successive dispensing events.

17. The system of claim 1, wherein the system is configured for retrofit installation onto existing water dispensers through a detachable base containing the one or more sensors and the processing unit.

18. The system of claim 1, wherein the system is configured to monitor non-water fluids including oils, fuels, or coolants, with calibration parameters adjusted according to a density of a monitored fluid.

19. A method for determining filter life of a water filtration device, comprising:
measuring, by one or more sensors, an initial weight of a water container associated with the water filtration device;
measuring, by the one or more sensors, a subsequent weight of the water container after dispensing water;
calculating, by a processing unit, a difference between the initial weight and the subsequent weight;
determining a cumulative volume of water filtered through the water filtration device based on sequential weight differences;
comparing the cumulative volume to a predefined filter capacity; and
indicating, through an indicator system, a remaining filter life or a need for filter replacement based on the comparison.

20. A method for determining a water level in a water filtration device, comprising:
detecting, by one or more sensors, a current weight of a water container;
converting the detected weight into a corresponding water volume by a processing unit;
comparing the converted water volume with a maximum storage capacity; and
displaying, through an indicator system, a water level status corresponding to the converted volume, wherein the indicator system provides a first output when the water level exceeds a threshold and a second output when the water level falls below the threshold.
